(19) United States
(12) Patent Application Publication
(10) Pub. No.: US 2006/0089433 A1
(43) Pub. Date: Apr. 27, 2006

(54) Ultraviolet protected polyethersulfones

(75) Inventors: Reuven Hugi, Nahariya (IL); Haim Geva, Haifa (IL)

Correspondence Address: PEARL COHEN ZEDEK, LLP, 1500 BROADWAY 12TH FLOOR, NEW YORK, NY, 10036, US

(73) Assignee: PALRAM INDUSTRIES (1990) LTD.

(21) Appl. No.: 11/209,726

(22) Filed: Aug. 24, 2005

Related U.S. Application Data
(60) Provisional application No. 60/620,340, filed on Oct. 21, 2004.

(51) Int. Cl. C08K 5/34

(52) U.S. Cl. 524/87

(57) ABSTRACT

Embodiments of the present invention are directed to polymeric compositions of polyethersulfone comprising hindered amine light stabilizer, benzoxazinone-based ultraviolet stabilizer and diphenylacrylate-based ultraviolet stabilizer.

### CROSS REFERENCE TO RELATED APPLICATIONS

This application claims benefit of U.S. Provisional Application No. 60/620,340, filed on Oct. 21, 2004, entitled, “ULTRAVIOLET PROTECTED POLYETHERSULFONES”, which is hereby incorporated by reference.

### BACKGROUND OF THE INVENTION

Ultraviolet (UV) radiation, for example from sunlight, may cause the degradation of many types of solid polymeric articles The degradation may cause discoloration, embrittlement or yellowing and deterioration of the article. The use of UV light absorbers and hindered amine light stabilizers (HALS) to stabilize polymeric materials is generally known in the art.

Benzotriazole-based UV stabilizers and benzoxazinone-based UV stabilizers may be used to stabilize certain polymeric materials and to make them more durable to UV light. These materials, however, cannot be applied to polyethersulfones for several reasons. Firstly, the durability of these materials is inadequate. Additionally, the chemical resistance of the polyethersulfone to various materials decreases substantially when these stabilizers are added to the polyethersulfone. Examples of these materials may be organic solvents, such as toluene, carbon tetrachloride, dimethylchloride, chloroform, acetone, and others. Lastly, severe plate-out problems may occur during the production of articles from polyethersulfone with known combinations of benzotriazole-based and benzoxazinone-basesd UV stabilizers.

### BRIEF DESCRIPTION OF THE DRAWINGS

For a better understanding of embodiments of the invention, reference is made to the accompanying drawings in which:

FIG. 1A is a graph showing the change in the yellowness index of various polyethersulfone samples as a function of the time that these samples were exposed to UV-A radiation.

FIG. 1B is a graph showing the change in the Luminous Transmittance (LT) of various polyethersulfone samples as a function of the time that these samples were exposed to UV-A radiation.

FIG. 2A is graph showing the change in the yellowness index of various polyethersulfone samples as a function of the time that these samples were exposed to UV-B radiation.

FIG. 2B is a graph showing the change in the Luminous Transmittance (LT) of various polyethersulfone samples as a function of the time that these samples were exposed to UV-B radiation.

FIG. 3A is graph showing the change in the yellowness index of various polyethersulfone samples as a function of the time that these samples were exposed to a Xenon Arc radiation

FIG. 3B is a graph showing the change in the Luminous Transmittance (LT) of various polyethersulfone samples as a function of the time that these samples were exposed to Xenon Arc radiation.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, formulation and compositions have not been described in detail so as not to obscure the present invention.

Some embodiments of the present invention are directed to various compositions of a molding polyethersulfone material containing a combination of one or more ultraviolet (UV) light absorbers (stabilizers) and one or more hindered amine light stabilizers. According to some embodiments of the present invention, the composition comprises benzoxazinone-based UV light stabilizer, diphenylacrylate-based UV light stabilizer and hindered amine light stabilizer (HALS). Throughout the specification and the claims, the terms “absorber” and “stabilizer” are interchangeably used.

According to some embodiments of the present invention, it has been found that in order to obtain an ultraviolet protected polyethersulfone which will maintain its chemical resistance and be easily manufactured, the following components may be present in the following parts by weight:

TABLE 1

| | |
|---|---|
| Polyethersulfone | about 85%-95% |
| Benzoxazinone-based UV light stabilizer | about 2%-10% |
| Diphenylacrylate-based UV light stabilizer | about 0%-5% |
| Hindered amine light stabilizer (HALS) | about 0.1%-0.5% |

The relative amounts of the different components of the composition may vary. According to some embodiments of the present invention, the relative amount of benzoxazinone-based UV light stabilizer may be 2 wt %-10 wt %, the relative amount of diphenylacrylate-based UV light stabilizer may be 1 wt %-5 wt %, and the relative amount of HALS may be 0.1 wt %-0.3 wt %.

Ultraviolet Light Stabilizer

Non-limiting examples of such UV light stabilizers may include benzophenones, hydroxybenzophenones, benzotriazoles, benzoxazinones, diphenylacrylates and derivatives thereof.

Specific non-limiting examples of such UV light stabilizers may include materials available commercially from Everlight Chemical Industrial Corporation, Taipei, Taiwan, under the names EVERSORB 78, EVERSORB 79, EVERSORB 80, which are examples of benzotriazoles Other non-limiting examples are materials available commercially from Cytec Technology co., ltd. under the names CHISORB 234, CHISORB 320, CHISORB 325, CHISORB 326, CHISORB 327, which are examples of benzotriazoles and CHISORB 328, which is an example of triazine-based UV light stabilizer. Yet other examples may be materials available commercially from Great Lakes Chemical Corporation under the names LOWILITE. 29, LOWILITE 36, which are examples of benzotriazoles.

Other examples are materials available commercially from Cytec Technology co., ltd. under the names, CYASORB UV-531 (benzophenone), CYASORB UV-1164 (triazine), CYASORB UV-5365 (benzotriazole), CYASORB UV-2908 (hindered benzoate), CYASORB UV-3638 (benzoxazine). Yet other non-limiting examples are materials available commercially from BASF under the names UVINUL 3000, UVINUL 3008, UVINUL 3040, UVINUL 3048, UVINUL 3049, UVINUL 3050, which are examples of benzophenones, UVINUL 3030, UVINUL 3035, UVINUL 3039, UVINUL 3088, which are examples of diphenyl acrylates.

Hindered Amine Light Stabilizers (HALS)

Non-limiting examples of hindered amine light stabilizers may include Cyasorb UV-3346, Cyasorb UV-3529, Cyasorb UV-4042, Cyasorb UV-3853, available from Cytec Industries Inc. New Jersey, USA, Eversorb 90, Eversorb 91, Eversorb 93, Eversorb 765, available from Everlight and Lowilite 62, Lowilite 77, Lowilite 92, Lowilite 94, available from Great Lakes Chemical Corporation.

Polyethersulfone is known to have good chemical resistance to various chemicals, such as Toluene. The chemical resistance of the polyethersulfone to certain chemicals may decrease, however, substantially when benzotriazole UV stabilizers and/or HALS are added to the polyethersulfone. It has been found based on tests performed according to “Standard Practice for Stress Crazing of Transparent Plastics” (ASTM F791-82) that compositions comprising the ingredients of table 1 maintain the good chemical resistance of pure polyethersulfone. The chemical resistance test and its results are described below in relation to Example 1.

Moreover, it has been found based on tests comparing changes in optical properties under UV exposure that the compositions of Table 1 have high ultraviolet resistance. The UV resistance tests were performed according the following standards: “Standard Practice for Operating Fluorescent Light Apparatus for UV exposure of Nonmetallic Materials” (ASTM G154), “Standard Procedure for Operating Xenon Arc Light Apparatus for exposure of Nonmetallic Materials” (ASTM G155), “Test Method for Yellowness Index of Plastics” (ASTM D1925-70), “Standard Test Method for Haze and Luminous Transmittance of Transport Plastics”—ASTM D1003-00, “Practice for Computing the Colors of Objects by Using the CIE System” (ASTM E308(85)). The UV resistance tests and their results are described in detail below in relation to Examples 1, 2, and 3.

### EXAMPLES

In the following examples of molding material with UV stabilizing compositions, component designations are in weight percentages. Furthermore, all the examples were prepared in a similar procedure as example 1, which preparation is described in more detail below. It is noted that the following examples do not limit in any way the scope of the present invention.

TABLE 2
Example 1

| Weight | |
|---|---|
| % | Ingredient |
| 7 | UV absorber, sold under the trade name of CYASORB UV-3638 |
| | by Cytec Industries Inc. |
| | (2,2′-(1,4-Phenylene)bis[4H-3,1-benzoxazin-4-one] |
| | Benzoxazinone-based UV absorber |
| 3 | UV absorber, sold under the trade name of UVINUL 3030 12 by |
| | BASF. |
| | (1,3-bis-[2′-cyano-3′-diphenylacryloyl)oxy]-2,2-bis-{[2-cyano- |
| | 3′,3′-diphenylacryloyl)oxy]methyl}propane |
| | Diphenylacrylate-based UV absorber |
| 0.2 | HALS, sold under the trade name of Lowilite 94 by Great Lakes |
| | Chemical Corporation |
| | (N,N′-bis(2,2,6,6-tetramethyl-4-piperidinyl)-1,6-hexanediamine, |
| | polymer with 2,4,6-trichloro-1,3,5-triazane and 2,4,4-timethyl- |
| | 1,2-pentamine) |
| 89.8 | Polyethersulfone, sold under the trade name of RADEL A by |
| | Solvay Advanced Polymers - USA. |

The material of Example 1 was prepared in the following method: The raw material of polyethersulfone was compounded with the UV absorbers and HALS using twin-screw extruder (Haake Rheomix CTW 100). The material was subjected to a torque of 40N*m. The temperature profile along the extruder is described in Table 3 below:

TABLE 3

| | Heating Zone | | | |
|---|---|---|---|---|
| | Zone 1 | Zone 2 | Zone 3 | Zone 4 |
| Temperature [° C.] | 260 | 270 | 280 | 270 |

The extrusion time (from the feeding zone to the nozzle) was approximately 3 minutes. Sheets having a thickness of 0.5 mm were extruded from the obtained granules. Then, a 110 mm die was attached to the Haake Rheomlx CTW 100 twin-screw extruder. The material was again subjected to a torque of 40N*m for approximately 3 minutes. The temperature profile along the extruder is described in below:

TABLE 4

| | Heating Zone | | | |
|---|---|---|---|---|
| | Zone 1 | Zone 2 | Zone 3 | Zone 4 |
| Temperature [° C.] | 270 | 290 | 310 | 300 |

Example 1 demonstrates a UV protected polyethersulfone comprising a benzoxazinone-based UV absorber, diphenylacrylate-based UV absorber, and HALS

TABLE 5
Example 2

| Weight | |
|---|---|
| % | Ingredient |
| 7 | UV absorber, sold under the trade name of CYASORB UV-3638 |
| | by Cytec Industries Inc. Benzoxazinone-based UV |
| | absorber |
| 0.2 | HALS, sold under the trade name of Lowilite 94 by Great Lakes |
| | Chemical Corporation |
| 92.8 | Polyethersulfone, sold under the trade name of RADEL A by |
| | Solvay Advanced Polymers - USA. |

Example 2 demonstrates a UV protected polyethersulfone comprising a benzoxazinone-based UV absorber and HALS.

TABLE 6
Example 3

| Weight | |
|---|---|
| % | Ingredient |
| 10 | UV absorber, sold under the trade name of CYASORB UV-3638 |
| | by Cytec Industries Inc. Benzoxazinone-based UV |
| | absorber |
| 0.3 | HALS, sold under the trade name of Lowilite 94 by Great |
| | Lakes Chemical Corporation |
| 89.7 | Polyethersulfone, sold under the trade name of RADEL A by |
| | Solvay Advanced Polymers - USA. |

Example 3 demonstrates another composition of UV protected polyethersulfone with a benzoxazinone-based UV absorber and HALS.

Ultraviolet Resistance Results

The materials described in Examples 1, 2 and 3 and a sample of pure polyethersulfone were tested for changes in their optical properties, namely changes in the yellowness index (ΔYI) and changes in the luminous transmittance (ΔLT), due to UV radiations from a QUV-A source, a QUV-B source, and a Xenon arc The degree of degradation in transparent thermoplastics may be estimated by the change in the yellowing index (ΔYI) of a material. This may be done by weathering tests as defined in “Srandard Terminology relating to Natural and Artificial Weathering Tests of Nonmetallic Materials” (ASTM G 113-01).

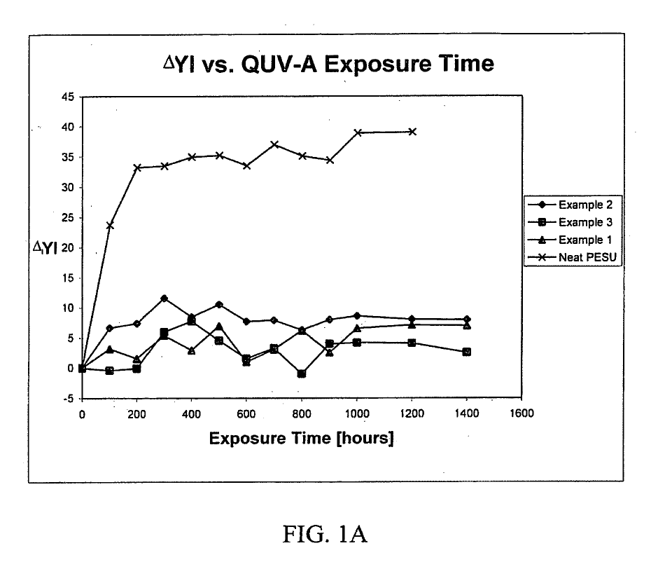

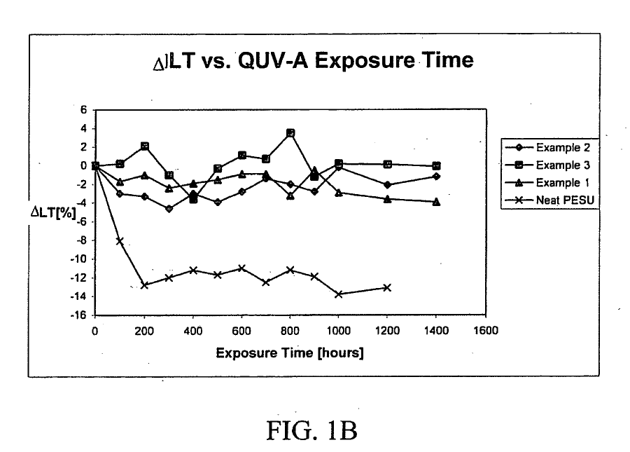

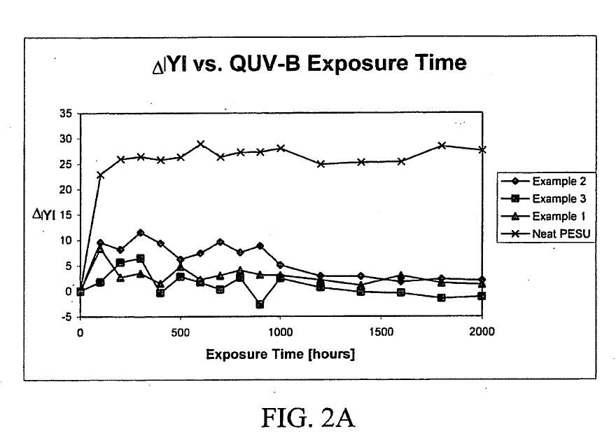

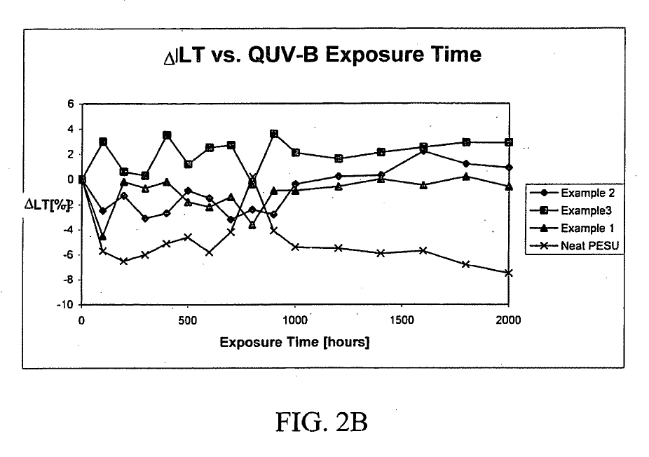

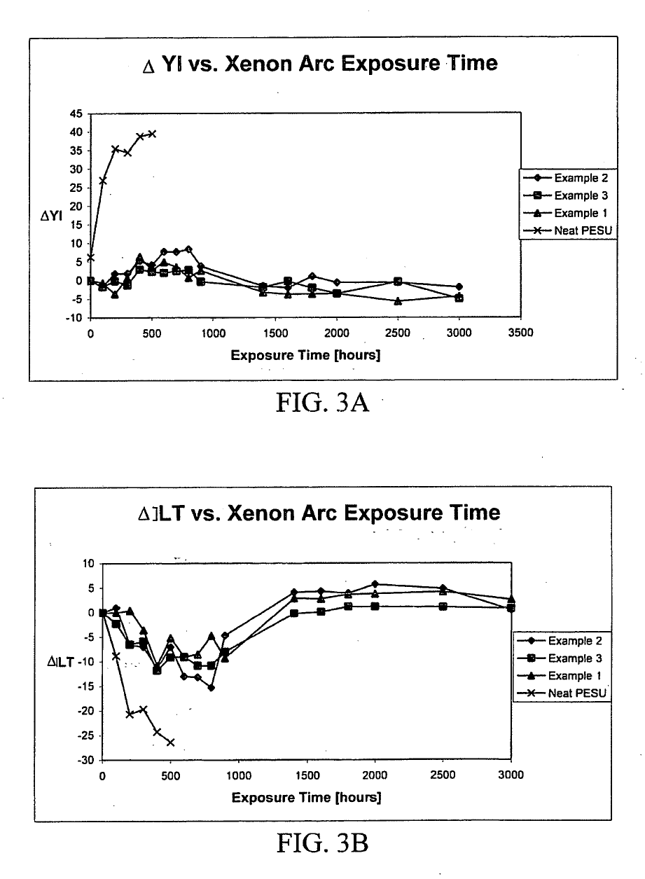

The changes in luminous transmittance, which is the ratio of the luminous flux transmitted by a body to the flux incident upon it as defined in the standard ASTM D1003-00, may serve as another index for estimating degradation in transparent thermoplastics. The results of these tests are presented in FIGS. 1A-3B.

Furthermore, the materials described in Examples 1, 2 and 3 and a sample of pure polyethersulfone were tested for changes in resistance due to UV radiations from a QUV-A source, a QUV-B source, and a Xenon arc. Samples of the pure polyethersulfone and polyethersulfone compositions were exposed to various UV radiation sources as described in “Standard Practice for Operating Fluorescent Light Apparatus for UV Exposure of Nonmetallic Materials”—ASTM GI 54 and “Standard Procedure for Operating Xenon Arc Light Apparatus for Exposure of Nonmetallic Materials”—ASTM G155. The exposure times after which cracks appeared in those samples were recorded. The results of these tests summarized in Table 7 below, clearly shows that the composition of Example 1 exhibits better results than the other materials.

TABLE 7

| | | Exposure Time until |
|---|---|---|
| | | cracks appears [hours], if |
| UV radiation | Material | any |
| QUV-A | Example 1 | 300 |
| | Example 2 | 100 |
| | Example 3 | 200 |
| | 100% polyethersulfone | 100 |
| QUV-B | Example 1 | — |
| | Example 2 | — |
| | Example 3 | 800 |
| | 100% polyethersulfone | 300 |
| Xenon Arc | Example 1 | 200 |
| | Example 2 | 100 |
| | Example 3 | 200 |
| | 100% polyethersulfone | 100 |

The worst results were obtained from the neat polyethersulfone and the best results were obtained by the composition of Example 1. For example, even after 2000 hours of exposure to QUV-B, no cracks appeared in the sample of Example 1, whereas after 300 hours cracks appeared in the pure polyethersulfone samples and after 800 hours cracks appeared in the sample of Example 3.

Chemical Resistance Results

Table 8 shows the results of the tests for chemical resistance that were performed according to ASTM F791-82. The chemical resistance is described by the Critical Stress (σ_{c}) measured in Mega Pascals [MPa], which is the critical stress for the appearance of cracks as a result of exposure to a certain chemical for 15 minutes. The samples included neat polysulfone (sold under the trade name Udel 3700H), neat polyethersulfone, polyethersulfone with UV absorbers as described in Tabele 2 (Example 1), and polysulfone with UV absorbers (identical to Example 1).

TABLE 8

| | | polysulfone + | | polyethersulfone + |
|---|---|---|---|---|
| chemical | polysulfone | UV absorbers] | polyethersulfone | UV absorbers |
| Toluene | failed | failed | 39.60 | 27.60 |
| Carbontetrachloride | 41.38 | 29.30 | 39.60 | 39.60 |
| Dichloromethane | 41.38 | 41.38 | 39.60 | 39.60 |
| Isopropylalchohol | 41.38 | 41.38 | 39.60 | 32.16 |

As can be seen from Table 8, the composition of Example 1, which has a good UV resistance, also maintains the good chemical resistance of pure polyethersulfone to many chemicals including Toluene.

In the examples above, the base molding material is polyethersulfone, however the combinations of UV light stabilizers and HALS according to some embodiments of the present invention may be equally applicable to protecting polysulfones from UV radiations.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A polymeric composition comprising:
polyethersulfone;
hindered amine light stabilizer;
benzoxazinone-based ultraviolet stabilizer; and
diphenylacrylate-based ultraviolet stabilizer.

2. The polymeric composition of claim 1, wherein the concentration of said polyethersulfone is 85%-95% by weight.

3. The polymeric composition of claim 1, wherein the concentration of said benzoxazinone-based ultraviolet stabilizer is 2%-10% by weight.

4. The polymeric composition of claim 1, wherein the concentration of said diphenylacrylate-based ultraviolet stabilizer is 0.1%-5% by weight.

5. The polymeric composition of claim 1, wherein the concentration of said hindered amine light stabilizer is 0.1%-0.5% by weight.

6. The polymeric composition of claim 1, wherein said benzoxazinone-based ultraviolet stabilizer is (2,2′-(1,4-phenylene)bis[4H-3,1-benzoxazin-4-one].

7. The polymeric composition of claim 1, wherein said diphenylacrylate-based ultraviolet stabilizer is (1,3-bis-[2′-cyano-3′-diphenylacryloyl)oxy]-2,2-bis-{[2-cyano-3′,3′-diphenylacryloyl)oxy]methyl}propane.

8. The polymeric composition of claim 1, wherein said hindered amine light stabilizer is (N,N′-bis(2,2,6,6-tetramethyl-4-piperidinyl)-1,6-hexanediamine, polymer with 2,4,6-trichloro-1,3,5-triazane and 2,4,4-timethyl-1,2-pentamine).
